(19) United States
(12) Patent Application Publication
(10) Pub. No.: US 2012/0151649 A1
(43) Pub. Date: Jun. 21, 2012

(54) TOWEL FOR EXERCISE AND TRAINING

(76) Inventor: Kevin Peterson, Houston, TX (US)

(21) Appl. No.: 12/975,338

(22) Filed: Dec. 21, 2010

(51) Int. Cl. A41D 13/00; D05C 17/02; B32B 1/08; B32B 3/06

(52) U.S. Cl. 2/69; 428/99; 428/90; 428/85; 428/34.1

(57) ABSTRACT

An exercise towel with a strap attached to a main portion for hanging the towel in a position convenient to the user and allowing the user's hands to remain unencumbered. The towel further comprises a method for attaching exercise assistance devices, a loop for safely securing headphone wires or other cords from dangling and a pocket to securing items or cooling substances which may enhance performance.

### BACKGROUND OF THE INVENTION

Perspiration (sweating, transpiration, or diaphoresis) is the production of a fluid consisting primarily of water as well as various dissolved solids (chiefly chlorides), that is excreted by the sweat glands in the skin. In humans, sweating is primarily a means of thermoregulation. Evaporation of sweat from the skin surface has a cooling effect due to the latent heat of evaporation of water.

When training or exercising it is almost inevitable that a person will sweat. Dripping sweat can be unsightly, uncomfortable, unsanitary, and unsafe. Sweat rolling down the body can be an inconvenience and a distraction. If it gets in one's eyes vision can be blurred. Sweat on the hands or equipment can cause a loss of grip resulting in a safety issue.

Many exercisers carry towels to wipe away sweat, but the towels can be as much of an issue as the sweat. Carried towels are a distraction and occupy one's hands which may not be an option depending on the activity. Towels which fall to the ground or are laid on surfaces can pick up germs and spread disease. Towels draped around the nape can be hot and sniffling and they can fall during exercise routines.

### BRIEF DESCRIPTION OF THE DRAWINGS

FIG. 1 illustrates a front view of an exercise towel with the strap unfastened in accordance with an exemplary embodiment of the invention.

FIG. 2 illustrates a training assistance device installed on an exercise towel in accordance with an exemplary embodiment of the invention.

FIG. 3 illustrates a rear view of an exercise towel in accordance with an exemplary embodiment of the invention.

FIG. 4 illustrates a close-up view of the rear of the exercise towel with the strap in the fastened position in accordance with an exemplary embodiment of the invention.

FIG. 5 illustrates a perspective view of the front of the exercise towel in accordance with an exemplary embodiment of the invention.

FIG. 6 illustrates a perspective view of the rear of the exercise towel in accordance with an exemplary embodiment of the invention.

FIG. 7A illustrates a person exercising while wearing the exercise towel in accordance with an exemplary embodiment of the invention.

FIG. 7B illustrates a person exercising while using the exercise towel in accordance with an exemplary embodiment of the invention.

### DETAILED DESCRIPTION OF THE PREFERRED EMBODIMENTS

A strap attached to a standard exercise towel allows it to be hung leaving the hands free and the towel secured from an unsanitary tumble to the floor. In the preferred embodiment a micro fiber towel is enhanced with a strap attached to one corner of the towel. The other end of the strap has a fastener which can be releasably attached to the towel. This allows the user to secure the towel by looping the strap around an object or body part.

In the preferred embodiment, the strap is passed around the neck at attached to the towel which hangs loosely in front of the user's torso placing it in easy reach during a routine. In one embodiment the strap may be attached to a corner of the towel. In another embodiment the strap may be attached to an edge of the towel. In another embodiment the strap may be attached to a surface of the towel at a location other than an edge.

In the preferred embodiment one end of the strap is permanently attached to the towel and the other end is removably attached. This arrangement prevents lose of the strap and allows the loop formed to be wrapped around objects. One can appreciate that both ends of the strap could be permanently attached forming a permanent loop. Further, one can appreciate that both ends of the strap could be removably attached thus allowing the strap to be removed from the towel completely for purposes of washing, or storage.

The removable attachment of the strap to the towel could be accomplished by a wide range of methods, examples include, but are not limited to: button/loop, hook/loop, snaps, magnetic catch, tying or knotting. The preferred embodiment is to use a hook and loop type material of a variety commonly referred to by the trade name Velcro® due to its convenient ease of use, durability, common usage, and low cost.

While in the preferred embodiment the main portion of the towel is made from a microfiber material due to its ability to wick away moisture. Many other tufted materials would also work in this application. In one embodiment, the main portion of the towel is made from a terry cloth material. In another embodiment, the main portion of the towel is made from a woven material. Further, one skilled in the art would appreciate that the towel could be made of any of a variety of suitable materials commonly used for towels.

In one embodiment the strap could be made from a similar material as the towel. This would allow it to absorb perspiration. In another embodiment, the strap could be made of a different material which may be less hot and stifling. In another embodiment the strap could comprise a hollow tube like structure allowing it to be filled with a cooling substance such as ice or a cooled gel filled structure.

While exercising, many people carry ipods®, MP3 players, radios, telephones or other entertainment devices. Other people may carry pedometers, heart rate monitors, or other exercise assistance or monitoring devices. In the preferred embodiment a small pocket like or loop like structure is provided to securing these devices either by placing them in a pocket, or clipping them to the loop or pocket opening. In another embodiment a Velcro like material is used to secure the device to the towel.

Many of entertainment devices are equipped with headphones. The cords to headphones can cause a particular hazard because they can get caught in equipment, or on swinging limbs. In the preferred embodiment an ‘earphone safety loop’ is attached to the strap for holding excess cords in a secure manner. It should be appreciated that the safety loop can be attached to the towel or strap in a variety of location with similar affect.

In addition to the small pocket for securing exercise assistance or entertainment devices, a larger pocket is disclosed as being stitched into the towel's main portion. This larger pocket can secure be used for a variety of purposes. In one embodiment, the larger pocket can hold ice or other cooling substances. In another embodiment the larger pocket is lined with a water proof material. In one embodiment the opening of the larger pocket is releasably closed to allow items to be secured in the pocket such that they will not fall out during aggressive activity.

A person can utilize the towel described above by attaching the strap loosely around their neck allowing the towel to hang conveniently in front of their chest. In this position the towel can be conveniently reached by either hand. Further the towel will easily catch sweat which drips from the face. With an MP3 player or other entertainment device attached to the towel and the excess cord attached to the safety loop a person utilizing the towel does not have to worry about routing a headphone cord or getting it tangled in the equipment. By filling the larger pocket with ice, the melting ice provides a constant source of cooling to the person's torso and extends their ability to perform before overheating.

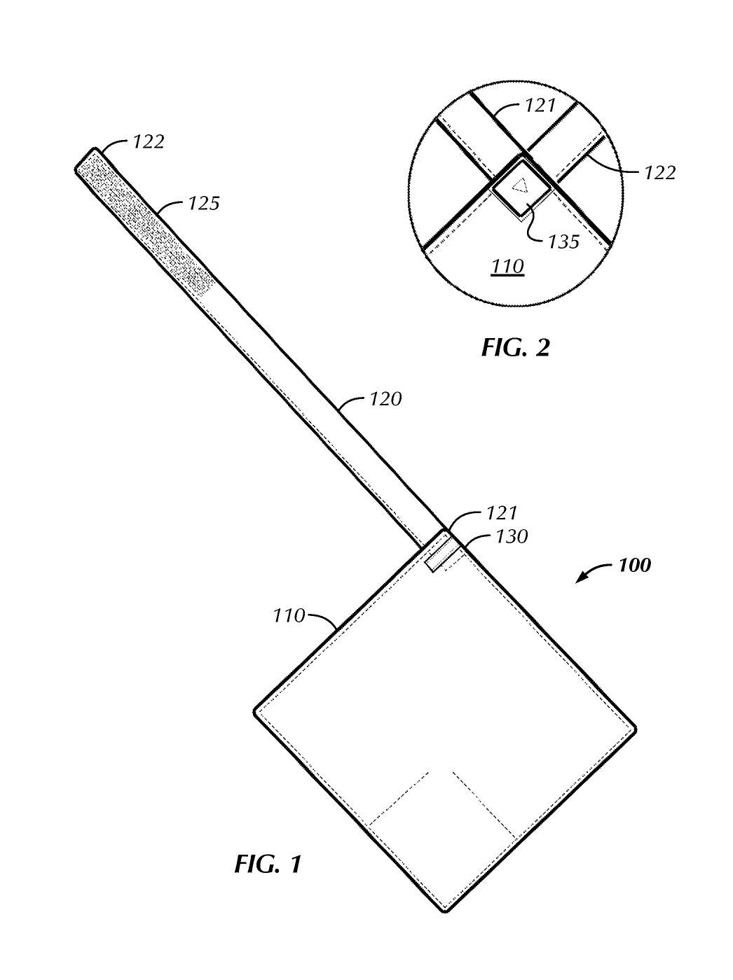

FIG. 1 illustrates a front view of an exercise towel with the strap unfastened in accordance with an exemplary embodiment of the invention. The towel 100 comprises a main portion 110 and a strap 120 having two ends 121 and 122. One end 121 of the strap 120 is attached to the main portion 110 of the towel 100. The other end 122 of the strap 120 contains a method of attaching 125 the strap to the main portion 110 of the towel 100 in such a way to form a loop from the strap 120. The towel 110 further comprises a loop or pocket 130 for attaching an exercise assistance device.

FIG. 2 illustrates a close-up view of one corner of the main body 110 with both ends of the strap 121 and 122 attached. In this view the strap 130 for attaching an exercise assistance device, is obscured by an illustrated exercise assistance device 135.

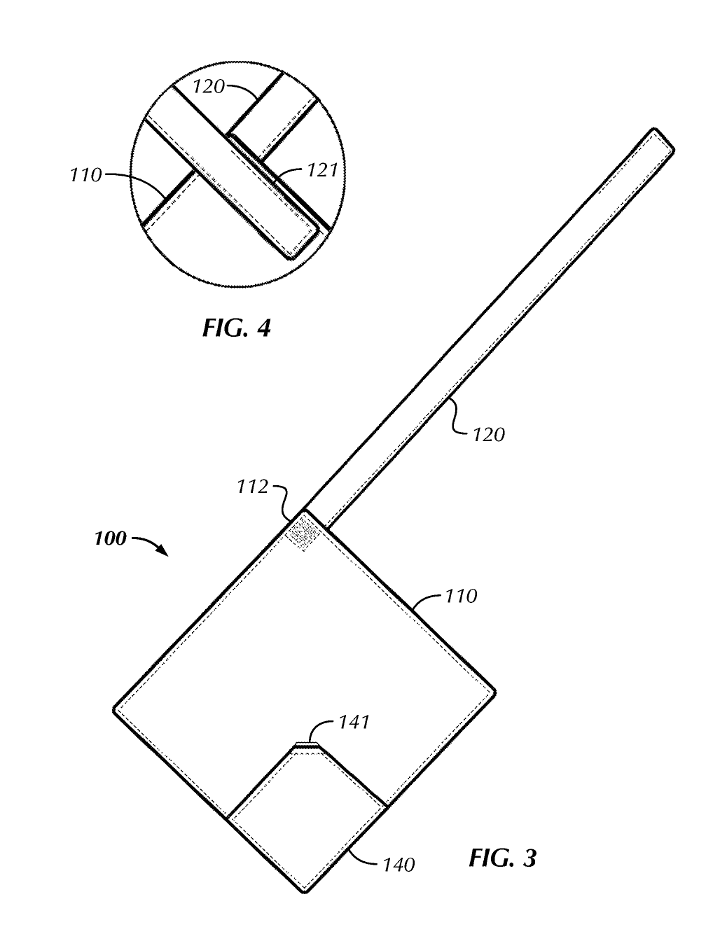

FIG. 3 illustrates a rear view of an exercise towel in accordance with an exemplary embodiment of the invention. The towel 100 is shown with the main portion 110 and the strap 120. From the rear view the method of attaching 112 the strap to the main portion 110 is visible. Also visible is a larger pocket 140 on the back of the main portion 110. In the illustrated embodiment, the larger pocket 140 has an opening 141 for inserting items.

FIG. 4 illustrates a close-up view of the rear of the exercise towel 100 with the strap 120 in the fastened position in accordance with an exemplary embodiment of the invention. The end 121 with the means for fastening 125 (not visible) is shown and illustrates how the strap is adjustable by extending it behind the main portion 110 of the towel 100.

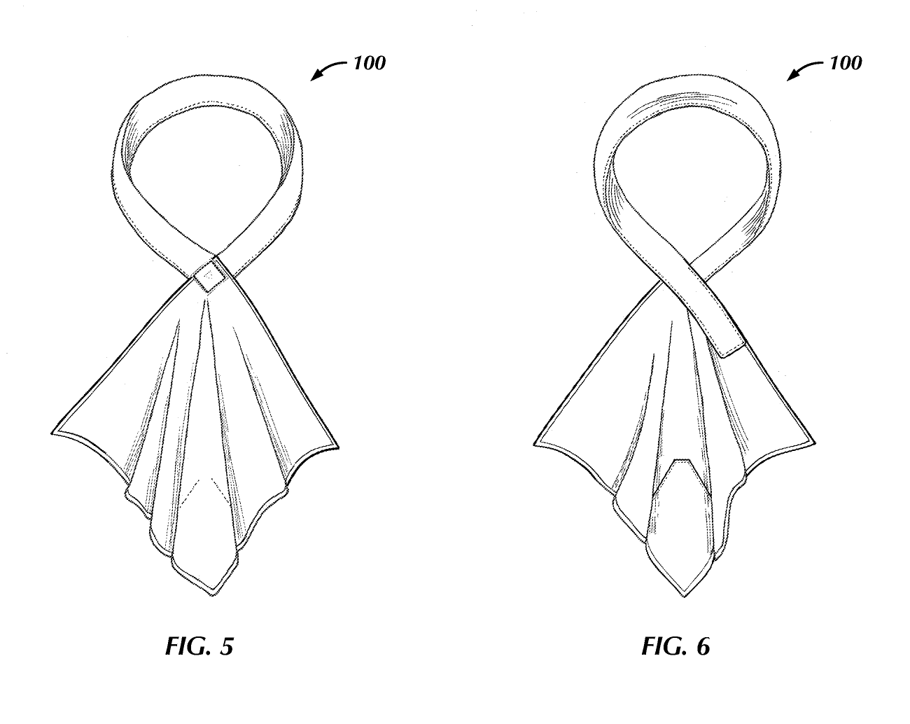

FIG. 5 and FIG. 6 illustrate a perspective view of the front of the exercise towel in accordance with an exemplary embodiment of the invention. These views show the strap in the attached position forming the loop that could hang around the users neck.

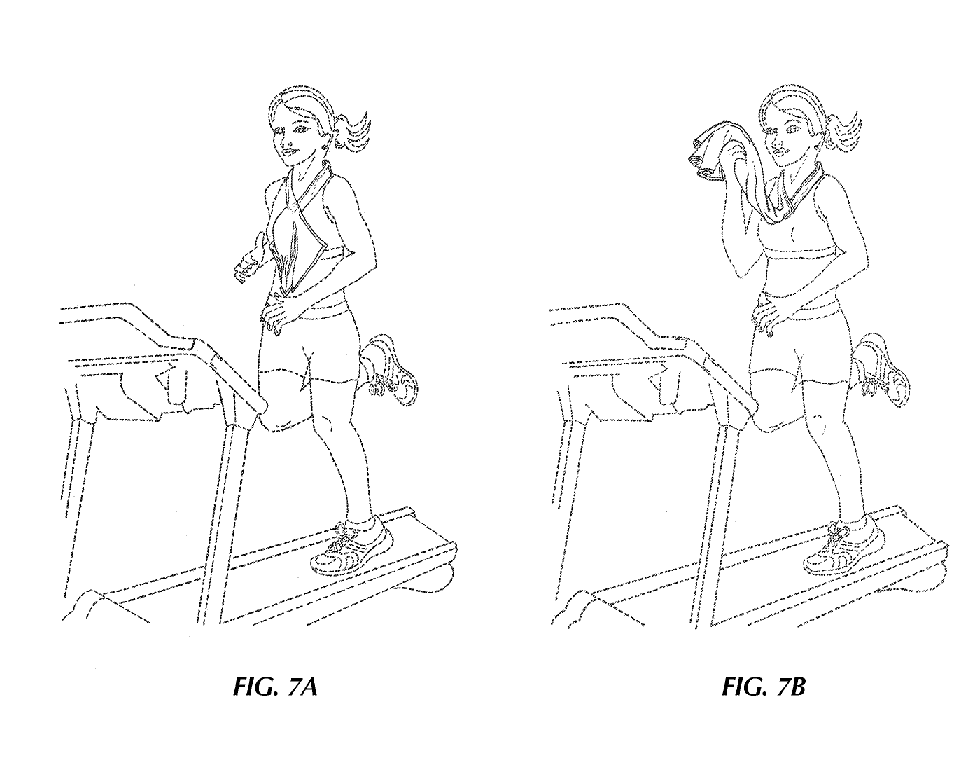

FIG. 7A and FIG. 7B illustrate a person exercising while utilizing the exercise towel in accordance with an exemplary embodiment of the invention. In FIG. 7A the user has the towel attached with the strap 120 around the person's neck, and the main portion 110 hanging freely in from of the torso. FIG. 7B shows the convenience of being able to reach the towel with either hand while continuing to exercise.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An exercise towel comprising:
main portion for wiping and absorbing sweat;
a strap attached to one edge of the main portion, extending substantially perpendicular to the edge; and
a fastener on the extended end;
where said extended end can be looped back and connected to the main portion.

2. An exercise towel as described in claim 1 wherein:
the main portion comprises a microfiber material.

3. An exercise towel as described in claim 1 wherein:
the main portion comprises a tufted material.

4. An exercised towel as described in claim 1 further comprising:
a compartment for securing an exercise assistance device.

5. An exercise towel as described in claim 4 wherein the exercise assistance device is a music playing device.

6. An exercise towel as described in claim 4 wherein the exercise assistance device is a communication device.

7. An exercise towel as described in claim 4 wherein the exercise assistance device is a performance recording device.

8. An exercise towel as described in claim 1 wherein the fastener is hook and pile type fastener.

9. An exercise towel as described in claim 1 wherein the fastener is a button and hole type fastener.

10. An exercise towel as described in claim 1 wherein the fastener is a snap fastener.

11. An exercise towel as described in claim 1 wherein the fastener is a magnetic fastener.

12. An exercise towel as described in claim 1 wherein the strap affixes to the corner of the main portion and extends out away from the main portion perpendicular to an edge proximate to the corner.

13. An exercise towel as described in claim 1 wherein the main portion further comprises:
a pocket of said material having an open end for insertably receiving items.

14. An exercise towel as described in claim 13 wherein the pocket further comprises a closure means for releasably closing said pocket to secure said items.

15. An exercise towel as described in claim 13 wherein the items comprises a cooling substance.

16. An exercise towel as described in claim 13 wherein the pocket is lined with water proof material.

17. An exercise towel as described in claim 4 further comprises a means for securing cords or cables wherein the exercise assistance device utilizes headphones or other devices having cords.

18. An exercise towel as described in claim 1 wherein the strap comprises an absorbent material.

19. An exercise towel as described in claim 18 wherein the strap is a tube like structure having an interior and exterior portion wherein the interior portion may be filled with a cooling substance.

20. A method for utilizing an exercise towel to prevent over heating comprising:
looping a strap secured to the edge of the towel around a body part; and
filling a pocket on the towel with a cooling substance.
